(19) United States
(12) Patent Application Publication
(10) Pub. No.: US 2007/0070045 A1
(43) Pub. Date: Mar. 29, 2007

(54) Entering a character into an electronic device

(76) Inventors: Shu-Chuan Sung, Taipei (TW); Alan S. Yang, Mundelein, IL (US); Li-Xin Zhen, Shanghai (CN)

Correspondence Address: MOTOROLA INC, 600 NORTH US HIGHWAY 45, ROOM AS437, LIBERTYVILLE, IL, 60048-5343, US

(21) Appl. No.: 11/236,474

(22) Filed: Sep. 27, 2005

(51) Int. Cl. G09G 5/00

(52) U.S. Cl. 345/173

(57) ABSTRACT

A method of entering a character into an electronic device (100) is provided. The method comprises automatically performing a scribed stroke character input mode (220) at a touch sensitive tablet (170) of the device (100) in response to receiving at least one scribed stroke on the touch sensitive tablet (215). Recognising an end of character input stroke sequence (225) and determining from the stroke sequence a list of potential stroked input characters (235). Displaying the list of potential stroked input characters on a display of the device (240). Automatically performing a key selection character input mode (320) in response to a actuation of at least one of a plurality of character input keys (165) of the device and determining one or more potential keyed input characters corresponding to sequential actuation of the at least one of the character keys (330).

### FIELD OF THE INVENTION

The present invention relates generally to the field of character input into an electronic device.

### BACKGROUND OF THE INVENTION

Portable handheld electronic devices such as handheld wireless communications devices (e.g. cellphones) that are easy to transport are becoming commonplace. Such handheld electronic devices come in a variety of different form factors and support many features and functions.

Cellular telephones, Personal Digital Assistants (PDAs), tablet computers and other similar portable electronic devices, and electronic devices in general, sometimes have an input tablet that is typically a touch screen providing a two-way user interface for data entry, invoking applications and menu traversing. Touch screens have evolved to allow a user to scribe and therefore input handwritten characters such as words, letters, alphanumeric strings, Asian characters (such as Chinese, Korean and Japanese characters) and other indicia into an electronic device. The electronic device then processes and compares the handwritten characters with characters stored in a recognition dictionary (memory), and identifies a best match. The best match may then invoke a command or identify the scribed characters as input data to the electronic device.

Some portable electronic devices additionally or alternatively offer a one-way touch sensitive input interface which receives scribed input from a user, but does not provide visual feedback as a touch sensitive screen would. An example of a one-way interface is the finger writing recognition (FWR) system available from Motorola Inc. in which a user scribes characters into a device such as a mobile phone using a touch sensitive tablet associated with the user input keys. Thus a user may enter the lines of a Roman alphabet or Chinese character into the device by running their finger across the keypad of the device in an appropriate sequence of contacts or strokes. An example device having this capability is the Motorola A668 mobile phone. Such a system can provide a convenient additional data entry method for low cost devices that do not possess a touch sensitive screen.

The integration of the touch sensitive tablet with user input keys allows a user to enter characters using one of two character input modes—that is by scribing strokes using the tablet or by actuating keys. Each mode of character entry has advantages and disadvantages. For example using the scribed character input mode, once learnt, allows for relatively large and user friendly scribing movements without the need for looking closely at the tablet, and therefore in some character entry situations is faster and more convenient than keyed character entry. However keyed character entry is typically more accurate as it does not always rely on a recognition engine to identify a character, or if it does the possibilities tend to be much more bounded or limited than those for scribed entry. Keyed entry does however typically require greater concentration on the keys as these may be small and their position unfamiliar compared with the lines of a scribed character.

For certain types of character entry, for example Asian languages with both complex characters and equivalent combinations of letters from another language such as English, the choice of scribed entry or keyed entry is more complicated. For example the Chinese language is traditionally comprised of complex characters which have given meanings, however in order for this language to be more easily interfaced with electronic and computing devices, equivalent sequences of letters from say the Roman alphabet can be used instead for entering data into electronic devices or controlling them. For example Pinyin comprises groups of three Roman letters which are equivalent to a traditional Chinese character. Thus a Chinese user of an electronic device must decide between entering traditional Chinese characters and Pinyin letters, depending on which is perceived to be easier or quicker. This can be achieved by selecting the most appropriate character entry mode.

### SUMMARY OF THE INVENTION

In general terms in one aspect the present invention provides a method of entering a character into an electronic device by automatically performing a scribed stroke character input mode in which scribed strokes are received at a touch sensitive tablet such as a finger writing key pad sensor array or touch sensitive display screen. The scribed strokes correspond to lines of a character, and a number of potential characters are recognised or determined following an end of character indication, for example a predetermined time out following lack of contact or finger-lift at the touch sensitive tablet. The potential scribed input characters are then displayed for selection by the user. The method also automatically performs a key selection character input mode in response to actuation of a character input key. Potential keyed input characters are determined in response to one or more key actuations.

By automatically recognising the type of character input mode and taking the appropriate actions, the method provides a more convenient and faster character input interface for a user of an electronic device. This can be useful for example in the situation where traditional Chinese characters are being entered using the scribed entry mode, but where the user has forgotten how to scribe the next traditional Chinese character, or the equivalent three lettered Pinyin keyed entry would be faster (than say nine strokes for the traditional character), or the next character is a number which is more easily entered with a single key actuation on most keypads. Similarly, in the English language for example, a user may find it faster to scribe letters but faster to key numbers; and so seamless character entry mode switching can speed up character entry and ease user fatigue.

In an embodiment, the potential scribed input characters are selected from a list following determination of the potential scribed input characters using a recognition engine. Similarly, potential keyed input characters can be selected from a list where there is more than one candidate potential keyed input character. Selection may be facilitated using a scribed scrolling stroke such as an up-down stroke over the touch sensitive tablet, which highlights different potential characters for selection. Selection may then be achieved in a number of ways, for example by further actuation of a key. Alternatively, particular keys may be allocated or associated with particular potential characters in the list in order to enable direct selection without scrolling by associated key actuation.

In an embodiment, keys may be used for both character entry, and selection of potential characters. The function of the actuated key can be determined from the duration or length of time of the actuation or holding down of the input character key.

In an embodiment, determination of a potential keyed input character follows a sequence of keys, for example three keys in the case of Pinyin.

In an embodiment, the touch sensitive tablet and the key pad are integrated to enable both finger writing using lightly scribed strokes over the keypad, and key actuation using pressure against a particular key. The duration of the key pressure or actuation may determine one of multiple key functions such as keyed input character entry or potential character selection.

In another aspect of the present invention there is provided an electronic device and/or a computer program which when executed on a suitable processor is arranged to carry out the methods described herein.

### BRIEF DESCRIPTION OF THE DRAWINGS

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic block diagram illustrating circuitry of an electronic device in accordance with the invention;

FIG. 2 illustrates a mobile phone comprising a finger writing recognition touch sensitive tablet;

FIGS. 3a-3c illustrate entry and selection of a scribed Chinese character using the mobile phone of FIG. 2;

FIGS. 4a-4b illustrate a method of entry of scribed input and keyed input characters according to an embodiment; and

FIGS. 5a-5f illustrate display screen shots corresponding to entry and selection of scribed and keyed Chinese characters using the method of FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to seamless scribed and keyed character entry into an electronic device. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a” does not, without more constraints, preclude the existence of additional identical elements in the process, method, article, or apparatus that comprises the element. Also, throughout this specification the term “key” has the broad meaning of any key, button or actuator having a dedicated, variable or programmable function that is actuatable by a user.

It will be appreciated that embodiments of the invention described herein may be comprised of one or more conventional processors and unique stored program instructions that control the one or more processors to implement, in conjunction with certain non-processor circuits, some, most, or all of the functions of seamless scribed and keyed character entry into an electronic device described herein. The non-processor circuits may include, but are not limited to, a radio receiver, a radio transmitter, signal drivers, clock circuits, power source circuits, and user input devices. As such, these functions may be interpreted as steps of a method to perform seamless scribed and keyed character entry into an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

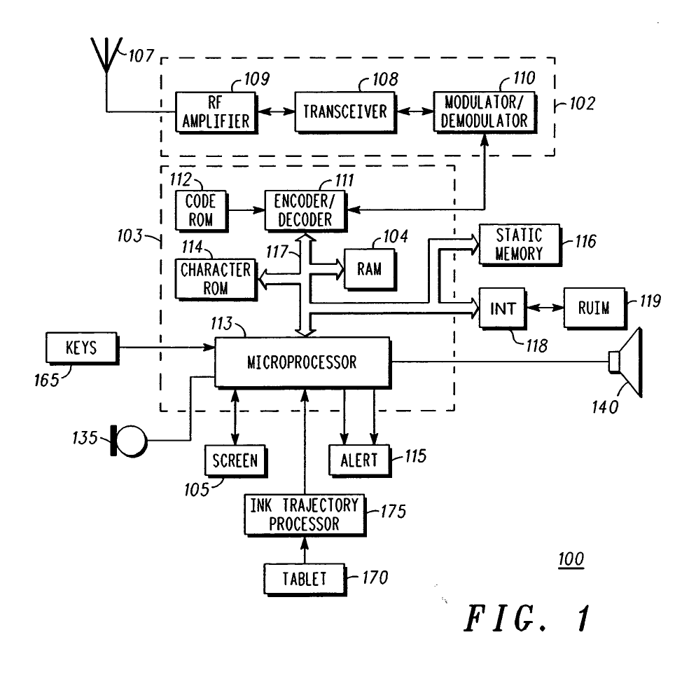

Referring to FIG. 1, there is a schematic diagram illustrating an electronic device 100, typically a wireless communications device, in the form of a mobile station or mobile telephone comprising a radio frequency communications unit 102 coupled to be in communication with a processor 103. The electronic device 100 also has a display screen 105 and keys 165. There is also an alert module 115 that typically contains an alert speaker, vibrator motor and associated drivers. The display screen 105, keys 165 and alert module 115 are coupled to be in communication with the processor 103. The electronic device also comprises a touch sensitive tablet 170 and an ink trajectory processor 175.

The processor 103 includes an encoder/decoder 111 with an associated code Read Only Memory (ROM) 112 for storing data for encoding and decoding voice or other signals that may be transmitted or received by the electronic device 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a Removable User Identity Module (RUIM) interface 118. The static programmable memory 116 and a RUIM card 119 (commonly referred to as a Subscriber Identity Module (SIM) card) operatively coupled to the RUIM interface 118 each can store, amongst other things, Preferred Roaming Lists (PRLs), subscriber authentication data, selected incoming text messages and a Telephone Number Database (TND phonebook) comprising a number field for telephone numbers and a name field for identifiers associated with one of the numbers in the name field. The RUIM card 119 and static memory 116 may also store passwords for allowing accessibility to password-protected functions on the mobile telephone 100.

The micro-processor 113 has ports for coupling to the display screen 105, the keys and the alert module 115. Also, micro-processor 113 has ports for coupling to a microphone 135 and al communications speaker 140 that are integral with the device.

The character Read Only Memory 114 stores code for decoding or encoding text messages that may be received by the communications unit 102. In this embodiment the character Read Only Memory 114, RUIM card 119, and static memory 116 may also store Operating Code (OC) for the micro-processor 113 and code for performing functions associated with the mobile telephone 100.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that couples the communications unit 102 to the processor 103.

The touch sensitive tablet 170 receives scribed strokes from a user's finger or stylus and although shown separately here for simplicity may be integrated with the keys 165 or the display screen 105 of the device 100. The scribed strokes are interpreted by the ink trajectory processor 175 as inks or lines of contact or touch across an xy co-ordinate system of the tablet 170. These inks are captured and forwarded to the microprocessor 113 for further processing. Similarly, although the ink trajectory processor is shown separately here for simplicity, it may be implemented by code stored in the static memory 116 and executed by the microprocessor 113.

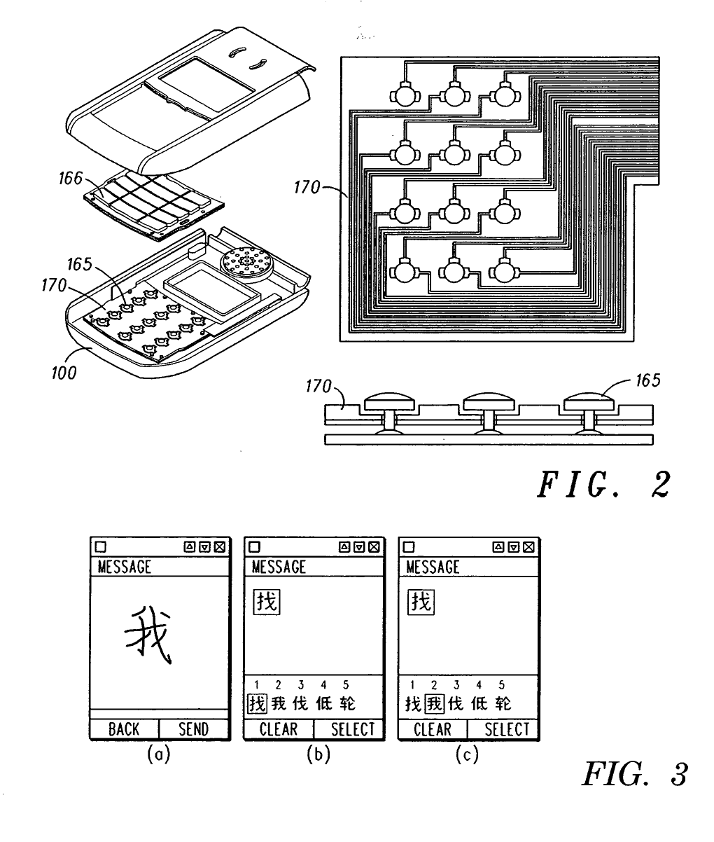

FIG. 2 illustrates in more detail the arrangement of the keys 165 and a touch sensitive tablet 170 which is integrated with the keys 165 overlaid by a keypad membrane 166. The touch sensitive tablet 170 provides a touch sensitive user interface on the electronic device 100 which allows for receiving user scribed strokes or lines of contact with the tablet 170 which correspond to lines of a character to be entered into the device. Such tablets are typically implemented using an array of capacitive sensors which detect changes in capacitance corresponding to the presence of a finger or other object such as a stylus. Detection of a scribing object such as a finger or stylus therefore does not require pressure against the sensor array or tablet, but typically just a light touch or contact against the surface of the tablet. Thus it is possible to integrate the keys and the touch sensitive tablet 170, as the keys require physical pressure for actuation whereas the capacitive sensors do not. Therefore it is possible to scribe a stroke on the tablet without actuating the integrated keys. Similarly actuation of a key can be used to disable the input from capacitive sensors surrounding the key in order to prevent any scribed input which may be registered when pressing the key. An example of a touch- sensitive tablet 170 is the finger writing recognition tablet on the A668 mobile phone available from Motorola Incorporated.

Whilst capacitive sensors are typically used, other sensor arrays may alternatively be used such as ultrasound sensors to detect the scribing object's position. Similarly the “activation” of a sensor may be configured to correspond to contact between a scribing object such as a finger and the surface of the tablet, or even close proximity of the distal end of a scribing object with the sensor such that actual physical contact with the tablet surface may not be required.

The changes in capacitance detected at the sensors are translated into a contact trajectory or scribed stroke by the ink trajectory processor 175 which is typically implemented in an ASIC, for example as available from Motorola Inc. The strokes of contact are captured by the ink trajectory processor 175 as ink trajectories with respect to the co-ordinate system of the tablet 170. These inks are then forwarded to the microprocessor 113 and may be displayed on a display screen 105 of the device 100 as inks within a drawing application or a character entry application for example. In a character entry application, a recognition engine will be called following the end of the scribed stroke entry in order to determine one or more potential characters corresponding to the displayed inks. An example of a character recognition engine is the finger writing recognition (FWR) engine available from Motorola Corporation. This is typically implemented by suitable code stored in the static memory 116 and executed by the microprocessor 113.

Where the tablet is a touch sensitive display screen, these inks are displayed at the points at which the scribed strokes are entered. Where the touch sensitive tablet 170 is not a touch sensitive screen as shown in the figure, there is no direct visual feedback from contact to corresponding lines of ink at the points of contact. However corresponding ink may be displayed in the separate display screen 105 of the electronic device 100. The use of a touch sensitive tablet 170 without direct visual feedback allows a cheaper non-touch sensitive display screen to be used. Alternatively or additionally, it allows data entry using a finger rather than a stylus.

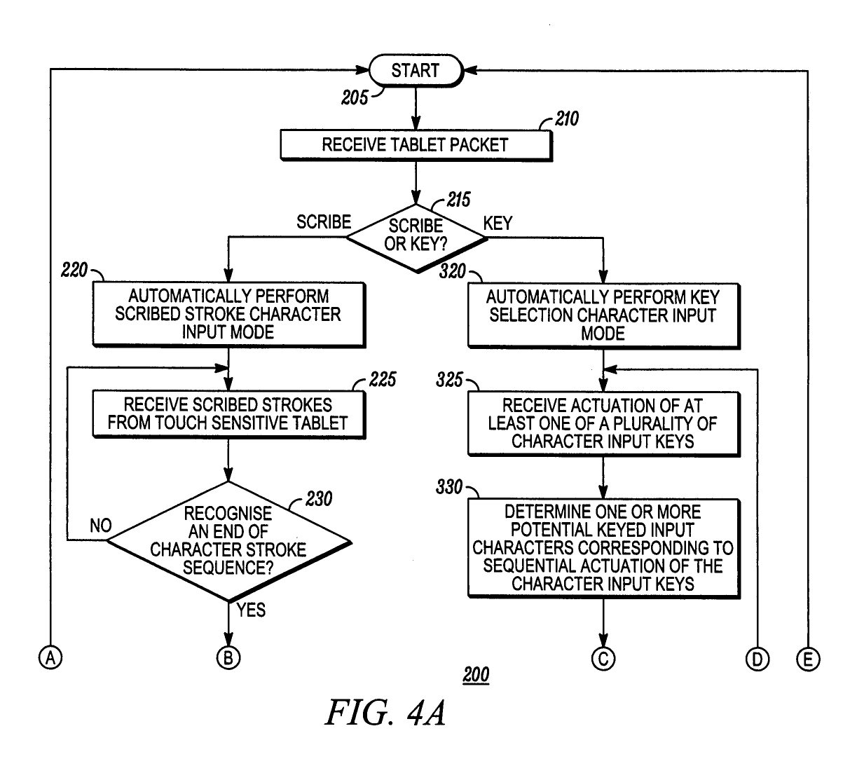

FIG. 3 illustrates a number of screens corresponding to entry of a Chinese character using a touch sensitive tablet similar to that of FIG. 2. The device 100 is configured to display ink in FIG. 3(a) that correspond to received scribed strokes at the touch sensitive tablet 170. Each time the user's finger leaves the keypad, a timer is activated which times the periods between user finger contacts with the tablet 170. As can be seen from the figure, the character comprises six lines, and there will be a period of non-contact or “finger-lift” with the tablet 170 between each scribed stroke entering a line. Typically a finger writing recognition system or similar scribed data entry system will determine that the user has finished scribing strokes for the current character following finger-lift or a lack of contact with the tablet for a predetermined time. For example, after 0.7 seconds the system recognises that the user has finished scribing the character strokes and attempts to determine potential characters corresponding to the scribed strokes. The predetermined time for recognition of the end of character scribing must be longer than a typical period of non-contact corresponding to the user moving between strokes of the same character.

The recognition result is displayed as a list of potential characters for the user to select from, as shown in FIG. 3(b). If the first or highlighted potential character or candidate is not the desired one, the user has to press a scroll key to highlight the desired character, and then press the “SELECT” key to select it as illustrated in FIG. 3(c). In a typical alternative arrangement, the keys 165 may be associated with corresponding potential characters and so it may be possible to select the desired potential character directly by actuation of the corresponding key.

The user may wish to switch to a different character entry mode using only keyed input. However in known arrangements this will require a menu selection and so consumes additional time, slowing character entry. Furthermore, different types of keyed character entry modes are available and will require separate selection. For example a Pinyin mode may be selected where potential characters are determined following every third keyed input or key actuation. Another character entry mode may use word recognition in limited keypad devices such as mobile phones where individual keys double up as number and multiple letter keys.

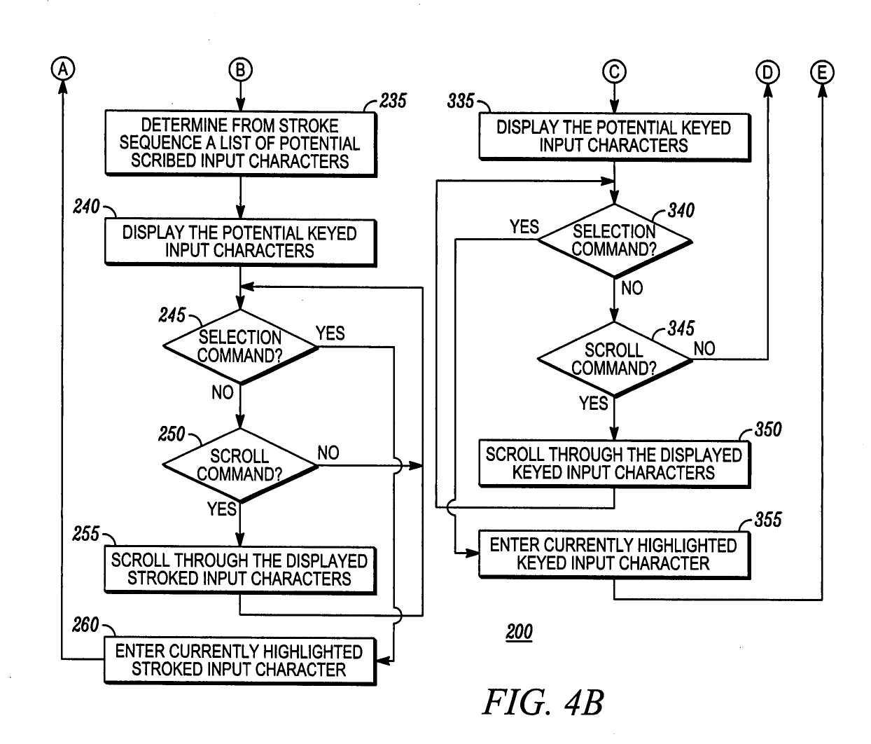

FIGS. 4a and 4b illustrate a method (200) of seamless scribed and keyed character entry according to an embodiment. The method provides for automatically switching between a scribed stroke character input mode and a key selection character input mode according to user action. Initially the method receives a packet from the user interface (210) such as a touch sensitive tablet having integrated keys. A packet is periodically received from the touch sensitive tablet 170, and may contain key actuation data and/or an ink trajectory input. The method determines whether the initially received packet corresponds to a key actuation (contains key data) or a scribed stroke input (captured ink) (215).

If it is determined that a scribed stroke has been received (215S), then the method automatically performs a scribed stroke character input mode (220). In this scribed stroke character input mode, the method receives one or more scribed strokes from the touch sensitive tablet 170 (225). The scribed strokes correspond to one or more lines of a character entered by a user using finger or stylus contact with the tablet 170. The electronic device 100 can be configured to display these lines as inks on the display screen 105 as they are being scribed by the user.

The method recognises an end of character input stroke sequence (230Y), for example using the time-out mechanism described above where there is no contact at the touch sensitive tablet 170 exceeding a predetermined time such as 0.7 seconds. The method then attempts to determine from the stroke sequence potential scribed input characters (235) using a recognition engine (113, 116). This will typically be implemented as software run by the microprocessor 113, and which compares the received stroke sequence or inks with characters in a recognition library stored in the character ROM 114. The determined potential scribed input characters are then displayed in a list on the display screen 105 in a character selection region (240). Typically the first potential scribed input character in the list is highlighted for selection by the user. The list provides for user selection from multiple potential stroked input characters for improved character entry accuracy. If a single potential character was automatically chosen as the most likely by the device, then this could be inaccurate due to user error, user inaccuracy of stroke input for example due to fatigue, or due to failings in the recognition software.

The method then determines whether the user has entered a selection command (245Y) in order to select the currently highlighted potential scribed input character, or a scrolling command (250Y) in order to scroll through the list of potential scribed input characters. The selection command may be a key actuation, or a predetermined scribed stroke such as tapping the tablet 170 for example.

The actuated key may be a dedicated selection key or if may also function as a character input key. A method for determining whether a character input key is used for selection is described in more detail below.

If a scrolling command is detected (250Y), the method scrolls through the list of potential scribed input characters in order to highlight different potential characters in the list (255). This process facilitates selection and the method returns to step 250 for further detection of incoming user commands such as selection or scrolling commands. The predetermined scrolling commands may be up-strokes or down-strokes at the tablet 170, in response to which the method scrolls left or rights (or up or down) through the list according to the stroke direction.

By recognising predetermined scribed scroll strokes as scrolling commands, the method avoids the need for the user to concentrate on the keys in order to scroll through the potential characters. This makes scrolling easier for the user and speeds up their character entry performance.

If a selection command is recognised (245Y), the currently highlighted potential scribed input character is entered into the device (260). Selection may be implemented by detecting actuation of any one of the keys 165 and interpreting this as selection of the highlighted character. In an alternative approach, each potential scribed input character may be associated with a corresponding key, so that actuation of a key by the user is interpreted by the method of selection of the corresponding potential character (245Y and 260). Entering the highlighted potential character may simply involve entering or displaying the selected character in an entered characters part of the display; which is different to a character selection part of the display where the list of potential characters is displayed. Entry of the selected character may also trigger other events such as word recognition or display of associated characters for selection by the user. Following entry of a character, the method returns to the start (205) where it determines whether the next user input (210) is a key actuation or a further scribed stroke (215).

If the received packet (210) reveals a character input key actuation (215K), then the method response by automatically performing a key selection character input mode (320). These may be soft keys on a touch sensitive screen, or physical or hard keys, which may be integrated with a finger writing recognition tablet as described above. In this key selection character input mode, the method receives one or more character input key actuations from the touch sensitive tablet 170 (325). Depending on the configuration of the mode, following one or a number of sequential received character input key actuation, the method determines one or more potential keyed input characters (330). For example where the keyboard is only a simple mobile phone numerical keypad, each key may be associated with several characters such as the number 2, letters a, b, and c, and possibly also further special characters. Where the device 100 has a full qwerty keyboard, a particular key may be associated with only one input character. In a further alternative, a sequence of key actuations may be required to determine the potential keyed input characters, for example in Pinyin, a sequence of three letters can be equivalent to a traditional Chinese character. Thus the method may be configured to determine potential traditional Chinese characters following three key actuations.

In a further alternative, rapid actuation of the same key may automatically scroll through its associated characters, so that for example two rapid actuations of key “2” on a standard mobile phone keypad determines the potential keyed input character “a”.

Following determination of potential keyed input characters, if any, these are displayed in a display of the device (335). The method then determines whether a selection command (340) or a scrolling command (345) has been entered by the user of the device. Typically the first potential character is highlighted for selection by the user. If neither a selection command nor a scroll command is detected, the method returns to receive a further character input key actuation in a sequential actuation of character input keys (325). Determination of potential keyed input characters is then attempted again (330). As noted above, the method may alternatively be configured to simply await three character input key actuations at step (325), before attempting determination of the potential keyed input characters at step (330).

If a scrolling command is detected (345Y), the method scrolls through the list of potential keyed input characters in order to highlight different potential characters in the list (350). This process facilitates selection, and the method then returns to step (340) for further detection of incoming user commands as selection or scrolling commands. The predetermined scrolling commands may be up-strokes or down-strokes at the tablet 170, in response to which the method scrolls left or rights (or up or down) through the list according to the stroke direction.

If a selection command is detected (340Y), then the currently highlighted potential keyed input character is entered into the device (355). Selection may be implemented by detecting selection actuation of any one of the selection keys 165 and interpret this as selection of the highlighted character (355). In an alternative approach, each potential character may be associated with a corresponding selection key, so that actuation of a selection key by the user is interpreted by the method of selection of the corresponding potential character (355). The selection keys may be different from the character entry keys.

Where the same physical or soft keys are used for character entry and selection, a method of distinguishing between the two functions is required. This can be achieved by detecting the length of time for which the key was actuated. For example a long period or duration of depression or actuation of a key (longer than a predetermined period) may correspond to a selection key, whereas a short actuation (less than the predetermined period of time) may correspond to a character input key, or vice versa. Other methods may also be used, for example a shift or control key could be pressed together with a character input key to change its function to a selection key.

As described above with respect to the scribed stroke character input mode, entering the highlighted keyed input potential character (355) may simply involve entering or displaying the selected character in an entered characters part of the display; which is different to a character selection part of the display where the list of potential characters is displayed. Entry of the selected character may also trigger other events such as word recognition or display of associated characters for selection by the user. Following entry of a character, the method returns to the start (205) where it determines whether the next user input (210) is a key actuation or a further scribed stroke (215).

Whilst the embodiment has been described with respect to the use of finger writing recognition (FWR) for the scribed stroke character input mode and Pinyin for the key selection character input mode, other seamless combinations of scribed and keyed input modes could alternatively be used. For example a touch sensitive display screen could be used to receive scribed strokes and a keypad could be used to receive English, TAP English, iTAP English, numbers or other special characters, Zhuyin or other letter based equivalents for traditional Asian characters. A device may be configured to offer multiple combinations of seamless character entry, for example through a menu system, so that a user may for example switch mode from FWR/Pinyin to display screen scribed English characters and keyed numbers and English letters by selecting an appropriate menu option. Furthermore, the keyed input mode need not rely on physical keys, but may alternatively use displayed “soft” keys on a touch sensitive display.

Seamless scribed and keyed character input mode methods aid user character entry into electronic devices, and especially small portable devices where character entry options, such as having a full qwerty keyboard, may be limited. This allows users to enter certain characters, for example English letters, using one method such as scribe stroke input rather than a limited non-qwerty keypad, but use another character entry method for other characters, such as numbers which may require only a single key actuation on the limited keypad. There is no need for the user to actively switch character entry modes, and so the user is encouraged to use whichever of the available seamless character input modes are available. This speeds up user character entry, especially on portable devices such as mobile phones, smartphones, and PDAs.

Embodiments offering seamless Asian character scribed input and key actuation character input modes provide further advantages. For example where a user is entering Asian characters, but has forgotten or is not sure of exactly how to scribe the next Asian character, they may use equivalent Pinyin based key actuations instead which they may remember more easily. Furthermore in some situations there may be a need to include English letters and numbers within a mainly Asian character document or entry, and with a suitably configured embodiment this can be achieved without requiring a new mode selection by the user. For example the user may wish to enter a new contact into their address book, the new contact having both a Chinese character name and an “English” name.

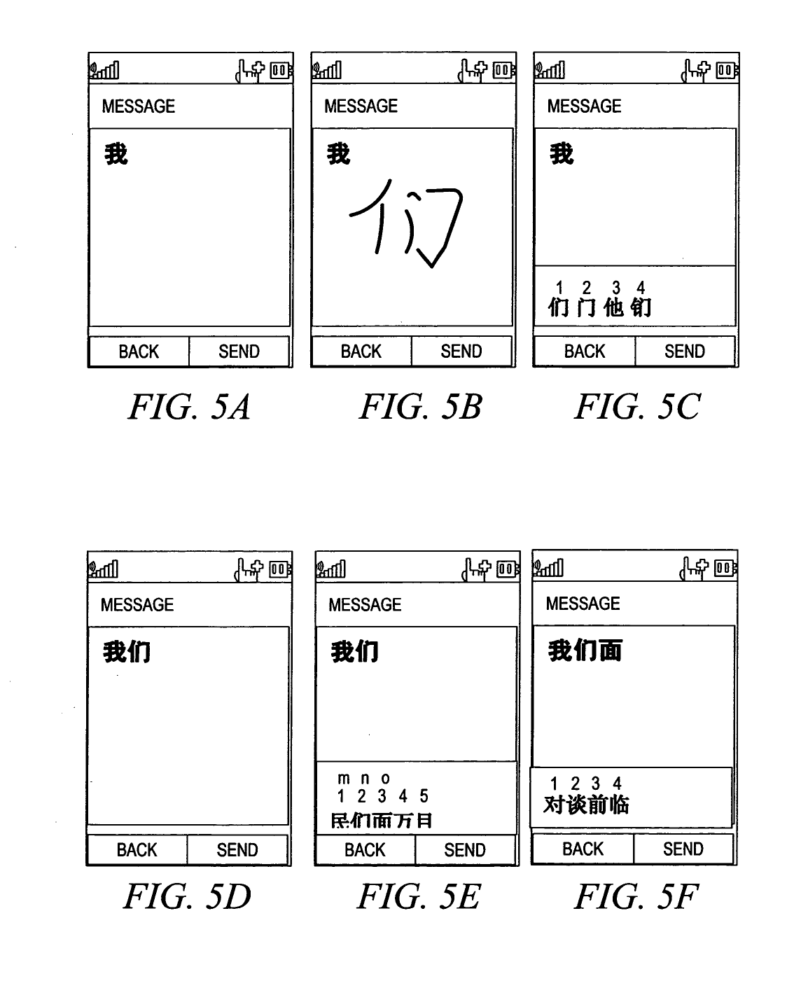

FIG. 5a-FIG. 5f illustrate screen shots on the display of the device as the device moves through the method of FIG. 4. FIG. 5a shows a display screen shot for a text message input program using seamless FWR scribed Chinese character input and Pinyin key selection character input modes. The first screen shows a first entered Chinese character. If the user scribes strokes on a touch sensitive tablet 170 as shown in FIG. 5b, then the program automatically performs a scribed stroke character input mode, in this case FWR. Once the user has scribed a number of strokes as shown, the program detects an end of character stroke sequence usually by detecting that there has been finger-lift for a time-out period. The program then determines a number of potential scribed or stroked input characters and displays these in a selection area of the display as shown in FIG. 5c. The user can then scroll through these using scrolling buttons or special scrolling scribed inputs such as up-down strokes. The speed of scrolling may be configured to be related to the speed of the predetermined special scribed stroke. The highlighted potential character can then be selected with a key press or actuation. Alternatively, each of the potential scribed input characters may be associated with a particular key (1,2,3,4) as shown, and selected by actuation of the appropriate key. Once a potential scribed input character has been selected, it is entered by the program into an entered characters part of the display screen as shown in FIG. 5d.

If none of the determined potential scribed input characters are correct or the user has changed their mind, they may return to scribing a new character or using keyed character entry (205). With this configuration, in order to distinguish between a new keyed input character entry and a selection of one of the potential scribed input characters, long and short duration key presses can be used. For example a short or “normal length” key actuation can be used for entering a new character using keyed input, whereas a long key actuation can be used for selecting the potential scribed input character associated with the respective key. The long key actuation may correspond to a length of time exceeding a predetermined period, or it may require actuation until the selected potential scribed input character is entered by the program. Alternatively the keyed input character functionality of the keys may be disabled so that only their selection functionality is available.

After a potential scribed input character is selected and entered as shown in FIG. 5d, if the user then presses a key, the program automatically performs a key selection character entry mode, in this case Pinyin. In this mode, any finger writing or scribed input detected at the tablet is ignored or deactivated. This may occur during key actuations on a keypad having the finger writing recognition system which typically detects capacitance changes. Pinyin uses a combination of three “English” characters to represent a Chinese character. The program may be configured to await a sequence of three keyed input characters before attempting to determine one or more potential keyed input characters, or a lesser number might be used. The determined potential keyed input characters are then displayed as shown in FIG. 5e. In the example illustrated, the Pinyin “mno” can correspond to five different Chinese characters shown in the character selection part of the display. The user may then scroll and/or select the highlighted character using any key actuation, or use direct actuation of a particular key (1,2,3,4,5) associated with the desired potential keyed input character as described above. Following selection, the selected character is entered in the entered character part of the display screen as shown in FIG. 5f.

The screen of FIG. 5f also shows associated characters which might normally be combined with the entered characters to form a dictionary word for example. If the device then receives further character input, scribed or keyed, then the associated characters are cleared to make way for the potential input characters. The device then automatically performs the scribed or keyed character input mode as appropriate.

Where there are no associated characters, the program then simply awaits further scribed input or keyed input in order to determine which character entry mode to use for the next character.

The scrolling functionality mentioned above in response to receiving predetermined scribed scroll strokes can be implemented in applications other than character entry. For example these scrolling commands could be used to scroll through a menu structure for example or for selecting potential characters from a different type of character entry and recognition method.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

We claim:

1. A method of entering a character into an electronic device, the method comprising:
automatically performing a scribed stroke character input mode at a touch sensitive tablet of the device in response to receiving at least one scribed stroke on the touch sensitive tablet;
recognising an end of character input stroke sequence and determining from the stroke sequence a list of potential scribed input characters;
displaying the list of potential scribed input characters on a display of the device;
automatically performing a key selection character input mode in response to a actuation of at least one of a plurality of character input keys of the device and determining one or more potential keyed input characters corresponding to sequential actuation of the at least one of the character input keys.

2. A method of entering a character into an electronic keyboard as claimed in claim 1, further comprising entering a scribed input character from the list of potential scribed input characters in response to an actuation of a selection key of the device.

3. A method of entering a character into an electronic keyboard as claimed in claim 2, wherein actuation of a selection key or a character input key is distinguished according to the duration of the actuation of the character input key.

4. A method of entering a character into an electronic keyboard as claimed in claim 1, wherein the determining of one or more potential keyed input characters is in response to sequential actuation of two or more character keys.

5. A method of entering a character into an electronic keyboard as claimed in claim 1, further comprising scrolling through the list of potential scribed input characters or the potential keyed input characters in response to a predetermined scribed stroke.

6. A method of entering a character into an electronic keyboard as claimed in claim 1, wherein the touch sensitive tablet is integrated with the character input keys of the device.

7. A carrier medium carrying processor code instructions which when executed on a processor are arranged to cause the processor to carry out the method of claim 1.

8. An electronic device comprising:
a processor arranged to automatically perform a scribed stroke character input mode in response to receiving at least one scribed stroke on a touch sensitive tablet of the device, and to recognise an end of character input stroke sequence;
a recognition engine arranged to determine from the stroke sequence a list of potential scribed input characters;
a display arranged to display the list of potential scribed input characters on a display of the device;
the processor further arranged to automatically perform a key selection character input mode in response to a actuation of at least one of a plurality of character input keys of the device;
and wherein the recognition engine is further arranged to determine one or more potential keyed input characters corresponding to sequential actuation of the at least one of the character input keys.

9. An electronic device as claimed in claim 8, wherein the processor is further arranged to enter a scribed input character from the list of potential scribed input characters in response to an actuation of a selection key of the device.

10. An electronic device as claimed in claim 9, wherein the processor is further arranged to distinguish between a selection key actuation and a character input key actuation according to the duration of the actuation.

11. An electronic device as claimed in claim 8, wherein the processor is further arranged to cause the recognition engine to determine one or more potential keyed input characters only following sequential actuation of two or more character keys.

12. An electronic device as claimed in claim 8, wherein the processor is further arranged to cause the display to scroll through the list of potential scribed input characters or the potential keyed input characters in response to a predetermined scribed stroke at the touch sensitive tablet.

13. An electronic device as claimed in claim 8, wherein the touch sensitive tablet is integrated with the character input keys of the device.
